(19) United States
(12) Patent Application Publication
(10) Pub. No.: US 2020/0247031 A1
(43) Pub. Date: Aug. 6, 2020

(54) MOLDING AND FILLING STATION OF A SYSTEM FOR MANUFACTURING FILLED CONTAINERS FROM PREFORMS BY MEANS OF FILLING MATERIAL INTRODUCED INTO THE PREFORM UNDER PRESSURE

(71) Applicant: KHS Corpoplast GmbH, Hamburg (DE)

(72) Inventors: Frank BERGER, Barsbüttel (DE); Benjamin JAISER, Hamburg (DE); Michael LINKE, Hamburg (DE); Rolf BAUMGARTE, Ahrensburg (DE); Michael LITZENBERG, Börnsen (DE)

(21) Appl. No.: 16/651,034

(22) PCT Filed: Oct. 22, 2018
(86) PCT No.: PCT/EP2018/078918

§ 371 Date: Mar. 26, 2020

(30) Foreign Application Priority Data
Nov. 7, 2017 (DE) 10 2017 010 272.4

(51) Int. Cl. B29C 49/46; B29C 49/12; B29C 49/58; B65B 3/02; B67C 3/26

(52) U.S. Cl. CPC B29C 49/46; B29C 49/12; B29C 49/58; B29C 2049/5803; B67C 3/2608; B29C 2049/4664; B65B 3/022

(57) ABSTRACT

The invention relates to a molding and filling station of a system for manufacturing filled containers from preforms (10) by means of liquid filling material (15) introduced into the preform (10) under pressure, said molding and filling station comprising a stretch rod (11) and a liquid duct (16) which can be controlled by means of a filling valve (14) and which is designed to surround the stretch rod (11) at least partially and ends in at least one outlet opening (17) which can be placed on the orifice (18) of the preform (10), the molding and filling station being characterized in that a gas barrier (20) is arranged in the liquid duct (16) between the filling valve (14) and the outlet opening (17).

The present invention relates to a molding and filling station of a system for manufacturing filled containers from thermally conditioned preforms by means of liquid filling material introduced into the preform under pressure.

Conventional containers, in particular bottles, are molded in the blow molding method by a molding gas which flows under pressure into a preheated preform and in a second step are filled with a filling material, in particular a liquid filling material.

Optimized methods developed recently provide that the preheated preform can be formed not by a pressurized gas and then filled, but rather can be formed and filled in a single step by means of a liquid filling material supplied under pressure. Such a method is known, for example, from DE 10 2010 007 541 A1.

For a preform to be able to be reshaped into a container, it is thermally conditioned, that is to say in particular it is preheated and provided with an appropriate temperature profile. Here, the body of the preform is heated, for example, to approximately 120° C. and is moldable, while the orifice area is allowed to reach only clearly lower temperatures, since the preform must be held at the orifice area in the molding and filling machine and must not undergo deformation there under the usual holding forces. For the thermal conditioning, a device for manufacturing filled containers has a heating section along which the preforms are guided and in the process provided with the desired temperature profile.

The molding process must occur rapidly, so that the heat stored in the preform is sufficient to obtain the preform in a manner so that it is plastically deformable until the end of the molding process. In the molding with liquid filling material, the preform must therefore be supplied with the volume necessary for the container in its final shape at high pressure and within a short time interval.

The preform moreover must be guided during its reshaping into the container so that an even and controlled reshaping can occur. This can occur by means of a stretch rod which, during the molding and filling process, performs a movement in the direction of the longitudinal axis of the container and in the process triggers the reshaping process by pressure application on the bottom of the preform and finally controls the reshaping by contact with the bottom area.

It is known to supply the filling material through the stretch rod. However, in filling stations according to the preamble, it is provided that the filling material is supplied via a liquid duct which at least partially surrounds the stretch rod. The liquid duct is supplied with a pressurized liquid via a controllable filling valve and has an outlet opening which can be brought in sealing engagement with the orifice of the preform so that the filling material can be pressed past the stretch rod without losses into the interior of the preform.

However, after the completion of the molding and filling process, it can easily occur that dripping of filling material from the outlet opening occurs. The filling valve by means of which the filling material flow is controlled is then in fact closed, but downstream thereof residual filling material volume is still located, which can run out.

From DE 10 2010 007 541 A1 and US 2013/0313761 A1 it is already known to minimize the dripping of filling medium by mechanical ways, in that a check valve is arranged in the flow path for the filling medium. This check valve closes in a spring-loaded manner as soon as the spring force exceeds the flow pressure of the filling material on the check element of the check valve. DE 10 2016 009 208 A1, published later, discloses a dripping prevention by means of a gas barrier which is arranged within a stretch rod.

The dripping of filling material leads to soiling of the molding and filling station and to losses of filling material. In addition, the molding and filling station is not immediately ready for use at full pressure. After the opening of the filling valve, the duct volume must only be supplied with filling material. For this purpose, air located therein must first be displaced before the full hydraulic pressure can be generated by the filling material.

The aim of the present invention is to develop a molding and filling station of a system for manufacturing filled containers from preforms by means of liquid filling material introduced under pressure into the preform, which comprises a stretch rod, in such a manner that no losses of filling material or contaminations by dripping filling material occurs.

The aim is achieved by a molding and filling station of a system for manufacturing filled containers from preforms by means of a liquid filling material introduced under pressure into the preform, which comprises a stretch rod and at least one liquid duct which can be controlled by means of a filling valve and which surrounds the stretch rod at least partially and ends in an outlet opening which can be engaged with the orifice of the preform.

According to the invention, a gas barrier is arranged in the liquid duct between the filling valve and the outlet opening.

The term gas barrier denotes an element arranged in the liquid duct, which, as a result of a suitable dimensioning or subdivision of the free flow cross section of the liquid duct, prevents air from being able to penetrate into the section of the liquid duct upstream of the gas barrier. A mechanical closing of the flow path is not necessary for this purpose, in contrast to the check valve of DE 10 2010 007 541 A1. A gas barrier is in fact based on the finding that a liquid which is at zero pressure in a line, due to its surface tension in conjunction with the environmental pressure, no longer flows out of the line as long as the outlet opening of the line is small enough. The surface tension then prevents the drop formation. The barrier effect of the gas barrier is the result of just the surface tension of the liquid.

A gas barrier can therefore consist, for example, of a plurality of sieve or flow ducts which subdivide the total cross section of the duct into several smaller cross sections, so that each individual cross section is small enough to achieve the desired effect.

The gas barrier can in particular have round or polygonal cross-sectional areas, in particular triangular or hexagonal cross-sectional areas.

The gas barrier can form ducts with a coaxial arrangement. Here the length of a duct is preferably greater than the diameter of a cross-sectional area. Thus, it is ensured that the liquid in the ducts must travel a longer distance before the duct is gas permeable. Pressure variations caused, for example, by temperature changes can thus be compensated without negatively affecting the gas barrier.

Which dimensions and relationships between duct diameter and duct length are suitable depends to a crucial extent on the filling material and its surface tension. The person skilled in the art can easily determine suitable dimensions theoretically or experimentally.

Advantageously, the gas barrier is arranged directly before the outlet opening of the flow duct. Directly here is understood to mean that the liquid volume remaining between the gas barrier and the outlet opening is negligibly small. The filling material possibly still exiting from the outlet opening can thus be minimized. Naturally, it is also conceivable that the gas barrier is arranged directly in the outlet opening.

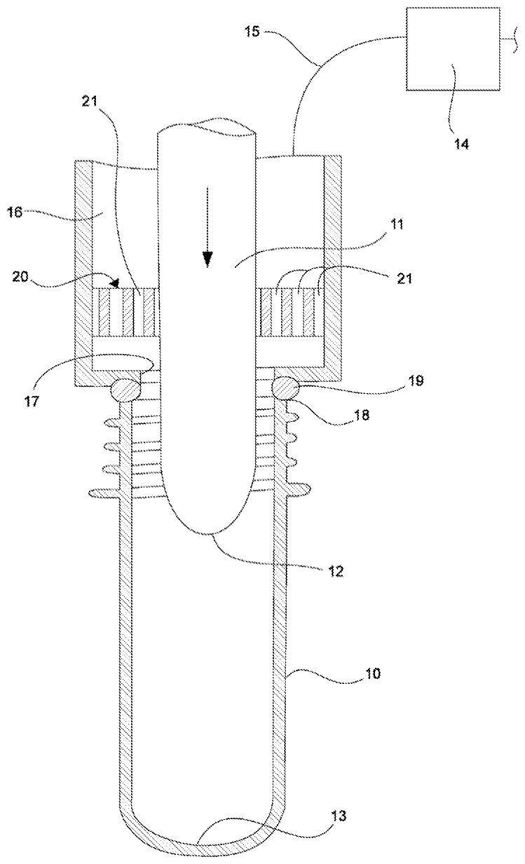

The invention is explained in greater detail below in reference to a FIGURE. The basic design of such a machine can here be implemented as described in DE 10 2010 007 541 A1, to which and to the disclosure of which as a whole explicit reference is made to avoid another repeated description, reference being made in particular to FIG. 1 and its description in paragraphs [0028] to [0035].

The single FIGURE diagrammatically shows the essential elements of a molding and filling station in the context of a machine for simultaneously molding and filling containers.

The FIGURE is understood to be an illustration of the principle of the invention. It is represented simplified and comprises only the components necessary for illustrating the invention. Based on his/her knowledge, a person skilled in the art can vary the size relationships of the individual components with respect to one another without problem or adapt then to the concrete needs.

In the FIGURE, a longitudinal section through a preform 10 into which a stretch rod 11 is introduced is shown. The stretch rod 11 is used for the at least temporary guiding and stretching of the preform 10 while it is being reshaped into a container. Typically, contact between the free end 12 of the stretch rod 11 and the bottom 13 of the preform 10 occurs first. When the stretch rod 11 is introduced farther into the preform 10, a longitudinal stretching of the preform 10 is brought about. After the completion of the stretching process or also already during the performance of the stretching process, a filling material 15 is introduced into the preform 10 via a filling valve 14 through a liquid duct 16 surrounding the stretch rod 11. The liquid flow can be controlled by the filling valve 14.

The liquid duct 16 surrounding the stretch rod 11 in the form of an annular duct comprises an outlet opening 17 which can be placed on the orifice 18 of the preform 10. Between outlet opening 17 and orifice 18, a seal 19 is provided, which ensures that, when the filling material 15 is introduced into the preform 10, no liquid exits between outlet opening 17 and orifice 18.

In the case represented, the seal 19 is formed as an O-ring.

A degassing of the preform 10 can occur using a degassing valve, not represented.

As mentioned, when the filling valve is open, the filling material 15 flows through the outlet opening 17 into the preform 10. In order to ensure that, after closing the filling valve 14, filling material 15 no longer leaves the liquid duct 16, that is to say that no dripping from the line which is then at zero pressure occurs, a gas barrier 20 is arranged according to the invention before the outlet opening 17.

The gas barrier 20 surrounds the stretch rod 11 and comprises multiple ducts 21 with, for example, round cross section.

In the embodiment example shown, the length of the ducts 21 in each case is a multiple of its diameter, which, as explained above, clearly increases the effectiveness of the gas barrier 20 in comparison to a sieve, for example, which is also conceivable as gas barrier.

Which dimensions and relationships between duct diameter and duct length are suitable depends to a crucial extent on the filling material and its surface tension. The person skilled in the art can easily determine suitable dimensions theoretically or experimentally.

In a manner not represented, the supply of the filling material into the preform can in addition also occur through the stretch rod 11 in order to increase the available supply cross section. This supply also occurs under valve control and, with regard to the supply duct for the filling material within the stretch rod as well, it is advantageous if said stretch rod is provided on the outlet side with the gas barrier, such as the gas barrier described and claimed with regard to the liquid duct surrounding the stretch rod. The claimed features can also advantageously be provided for this gas barrier in the supply duct in the stretch rod.

1-6. (canceled)

7. A molding and filling station of a system for manufacturing filled containers from a preform by introducing a liquid filling material into the preform under pressure, said molding and filling station comprising:
a stretch rod; and
a liquid duct in fluid communication with a filling valve;
wherein the liquid duct at least partially surrounds the stretch rod and ends in at least one outlet opening that is configured for placement on an orifice of the preform, and
wherein a gas barrier is arranged in the liquid duct between the filling valve and the outlet opening.

8. The molding and filling station according to claim 7, wherein the gas barrier subdivides a cross section of the liquid duct into a plurality of gas barrier ducts.

9. The molding and filling station according to claim 8, wherein the plurality of gas barrier ducts have round or polygonal cross-sectional areas.

10. The molding and filling station according to claim 8, wherein the plurality of gas barrier ducts have triangular or hexagonal cross-sectional areas.

11. The molding and filling station according to claim 8, wherein the plurality of gas barrier ducts have a coaxial arrangement.

12. The molding and filling station according to claim 11, wherein each of the plurality of gas barrier ducts has a length that is greater than a diameter of its cross-sectional area.

13. The molding and filling station according to claim 7, wherein the gas barrier is arranged proximal to the outlet opening.
